(19) United States
(12) Patent Application Publication
(10) Pub. No.: US 2009/0119118 A1
(43) Pub. Date: May 7, 2009

(54) METHOD FOR PROVIDING TISSUE PRODUCTS HAVING COORDINATED DECOR FEATURES

(76) Inventor: Rachael Eden Walther, Union, KY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/935,509

(22) Filed: Nov. 6, 2007

(51) Int. Cl. G06Q 10/00

(52) U.S. Cl. 705/1

(57) ABSTRACT

A method of customizing a tissue product, having the steps of: selecting a plurality of different architectural décor or home décor styles; categorizing the architectural décor or home décor styles into style groups; selecting a plurality of style groups; selecting at least one design that is representative of each style group; applying the selected designs to one or more tissue products, so that the tissue products represent the style group.

### FIELD OF THE INVENTION

The present invention relates to a method of providing tissue products and packaging having features selected or otherwise coordinated with architectural or home décor features.

### BACKGROUND OF THE INVENTION

Tissue products such as paper towels, toilet tissue and facial tissue, are commonly provided with a variety of aesthetic as well as functional features. For example, tissue products are provided with a variety of floral or other graphic designs on the tissue structure or the packaging. They also may be available in a variety of colors, have a variety of scents or packaging designs.

Furthermore, tissue products may be chosen by consumers to reflect their décor preferences. These tissue products are generally placed in locations in the home of consumers so that they are readily available for use by the consumer. Since these products are generally sitting out on countertops or in plain view in bathroom, bedroom, family room, or kitchen areas, many consumers consider that these products are also décor accessories. As such, these products have the potential to be a focal point of the room or to add décor interest to the room in which they are displayed and used. Consumers, hence, want the color palette and the design patterns of their tissue products to match the décor of their home and to reflect the consumer's home décor tastes and preferences.

In addition some consumers prefer clutter free living areas in their homes or work areas. Tissue products that serve the dual function of being a décor accessory, as well as being readily available to serve a variety of useful tasks, are desirable.

Therefore a need exist for providing consumers with a wider variety of tissue products that will be more readily coordinated to the décor of the consumer's home or office areas.

### SUMMARY OF THE INVENTION

In one embodiment the present invention relates to a method of customizing a tissue product, comprising the steps of: selecting a plurality of different architectural décor or home décor styles; categorizing the architectural décor or home décor styles into style groups; selecting a plurality of style groups; selecting at least one design that is representative of each style group; applying the selected designs to one or more tissue products, so that the tissue products represent the style group, wherein the tissue product comprises a tissue package and a fibrous structure; and optionally, providing décor information on the tissue package selected from the group consisting of painting information, wallpaper information, candle scents, room accessory information, furniture information, flooring information, lighting information, decorating supplier information, decorating coupons, decorating supplier advertising, style group identifying information, and combinations thereof.

### BRIEF DESCRIPTION OF THE DRAWINGS

While the specification concludes with claims particularly pointing out and distinctly claiming the present invention, it is believed that the present invention will be better understood from the following description in conjunction with the accompanying drawings, in which like reference numerals identify like elements and wherein:

FIG. 1 illustrates a flow diagram of method steps according to one embodiment of the invention.

FIG. 2 illustrates a flow diagram of method steps according to another embodiment of the invention.

### DETAILED DESCRIPTION OF PREFERRED EMBODIMENTS

### Definitions

“Sanitary tissue product” or “tissue product” as used herein means a wiping implement for post-urinary and/or post-bowel movement cleaning (toilet tissue or wipe products), for otorhinolaryngological discharges (facial tissue products) and/or multi-functional absorbent and cleaning uses (absorbent towels such as paper towel products, table napkins and/or wipe products). The sanitary tissue products of the present invention may comprise one or more fibrous structures and/or finished fibrous structures, traditionally, but not necessarily, comprising cellulose fibers. In one embodiment, the tissue products of the present invention include tissue-towel paper products.

A “tissue-towel paper product” refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the fibers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

### Method of Customizing a Tissue Product

In one embodiment the present invention relates to a method of customizing a tissue product, comprising the steps of: selecting a plurality of different architectural décor or home décor styles; categorizing the architectural décor or home décor styles into style groups; selecting a plurality of style groups; selecting at least one design that is representative of each style group; applying the selected designs to one or more tissue products, so that the tissue products represent the style group.

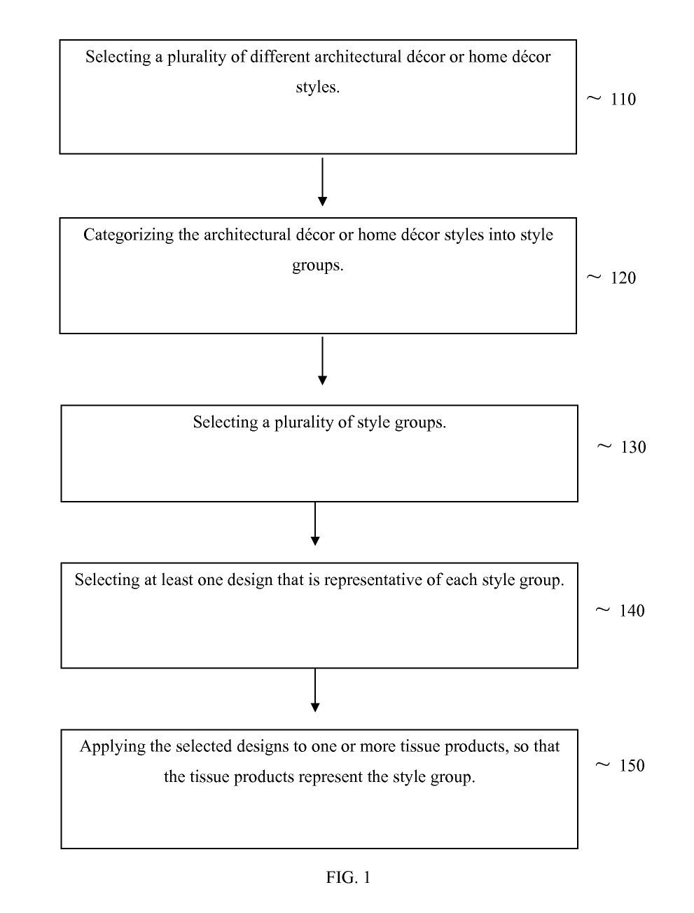

In one embodiment the steps of the method herein are illustrated in FIG. 1:

1. Selecting a Plurality of Different architectural Décor or Home décor Styles 110.

As used herein “home décor styles” include styles for the family room, bathroom, bedroom, and kitchen areas.

The architectural décor or home décor styles may generally be based on time periods in which the designs and styles originated, as well as geographical region or countries of origin.

The architectural décor or home décor styles may be selected from the group consisting of, but not limited to, art deco, art nouveau, arts and crafts, Asian, Boroque, Beidermeir, British Colonial, contemporary, cottage, country, eclectic, English, English country, Federal, French Empire, French country, French provincial, Jacobean, Mediterranean, Mission, Moroccan, Neoclassical, Old World, rustic, Scandinavian, Shaker, Southwestern, Traditional, transitional, Tudor, Victorian, Empire, Renaissance, Louis the IV through Louis the VI, Queen Anne, Chippendale, Hepplewhite, Sheraton.

2. Categorizing the Architectural Décor or Home Décor Styles into Style Groups 120.

The next step in the method of the invention is to categorize the architectural décor or home décor styles into style groups. Since there are many architectural décor or home décor styles to choose from, it may be useful to further group these architectural décor or home décor styles into style groups. In one embodiment the style groups are selected from the group consisting of art deco, art nouveau, arts and crafts, Asian, Boroque, Beidermeir, British Colonial, contemporary, cottage, country, eclectic, English, English country, Federal, French Empire, French country, French provincial, Jacobean, Mediterranean, Mission, Moroccan, Neoclassical, Old World, rustic, Scandinavian, Shaker, Southwestern, Traditional, transitional, Tudor, Victorian, Empire, Renaissance, Louis the IV through Louis the VI, Queen Anne, Chippendale, Hepplewhite, Sheraton.

In another embodiment the architectural décor or home décor styles are further grouped together where similar styles are grouped together. For example, French country, cottage, country may be grouped into one style group. In another example, art deco, art nouveau, Mission, and arts and crafts may be grouped together into one style group, and in another example, contemporary, Scandinavian, transitional, may be placed into one style group.

In one embodiment the style group is highlighted or marked in some form on the tissue package. For example, the style group may be given a brand name so that consumers associate the style group with source identifier, e.g. a single source manufacturer.

In one embodiment, to categorize the architectural décor or home décor styles into style groups, consumers may be presented with questionnaires and surveys to evaluate and categorize various architectural décor or home décor styles into style groups. This information may be collected via the internet, email, telephone, in-person, and/or via conventional mail.

### 3. Selecting a Plurality of Style Groups 130.

The next step in the method is selecting a plurality of style groups. Generally the present invention comprises at least about 2 style groups, and/or at least about 3 style groups. In one embodiment the number of style groups is selected to have the minimum number of style groups that will appeal to the greatest number of consumers. In one embodiment, to select style groups, consumers may be presented with questionnaires and surveys to evaluate and compare the appeal of various architectural décor or home décor styles to particular consumer groups (e.g. different age groups, cultures, different geographical regions, etc.). This information may be collected via the internet, email, telephone, in-person, and/or via conventional mail.

4. Selecting at Least One Design that is Representative of Each Style Group 140.

Another step in the method of the invention is to select at least one design that is representative of each style group. In one embodiment the design, for each style group, is selected to appeal to the greatest number of consumers for that style group. In one embodiment, to select designs that are representative of each style group, consumers may be presented with questionnaires and surveys to evaluate and compare the appeal of various designs and whether these designs represent the style groups. Consumers may be grouped based on their preference for certain style groups, etc. Again, this information may be collected via the internet, email, telephone, in-person, and/or via conventional mail. In addition professional interior designers may be consulted regarding the selection of designs that represent each style group.

The design may be, for example, a photograph of a design to be applied to the tissue package or printed onto the fibrous structure. As used herein, “design” shall include, without limitation, computer scanned images, drawings, photographs, logos, single color designs, multi-color (including black and white) designs, fabrics, wovens, embossments, deformations, print, and combination thereof. In another embodiment the shape of the tissue package may further coordinate with the design, for example a geometric shape with sharp angles to be used in conjunction with a contemporary style group or a curved package shape to be used in conjunction with a traditional style group.

5. Applying the Selected Designs to One or More Tissue Products, so that the Tissue Products Represent the Style Group 150.

Another step in the method of the invention is to apply the selected designs to one or more tissue products, so that the tissue products represent the style group. In one embodiment the tissue product comprises a tissue package and a fibrous structure. In another embodiment the design is applied to only the tissue package and/or applied only to the fibrous structure. In another embodiment the design is applied to both the tissue package and the fibrous structure. The design may be applied to the tissue products, tissue package, fibrous structure in any method known in the art. For example, the design may be embossed or printed on the fibrous structure.

In one embodiment of the present invention, the fibrous structure and/or tissue package has a plurality of embossments of a design that represents the style group. Suitable means of embossing include those disclosed in U.S. Pat. Nos. 3,323,983 issued to Palmer on Sep. 8, 1964; 5,468,323 issued to McNeil on Nov. 21, 1995; 5,693,406 issued to Wegele et al. on Dec. 2, 1997; 5,972,466 issued to Trokhan on Oct. 26, 1999; 6,030,690 issued to McNeil et al. on Feb. 29, 2000; and 6,086,715 issued to McNeil on July 11. Another process known for forming deformations in flexible films include the passing of a continuous film material between a pair of matched forming rolls to form an intentional pattern of deformations in the film, such as processes disclosed in U.S. Pat. Nos. 5,554,093; 5,575,747; 5,723,087; 5,518,801; 5,156,793; 7,172,801 and 6,394,652.

Furthermore, the design may be printed on the tissue package and/or fibrous structure. An exemplary process for printing a web structure is the use of a rotogravure process. A rotogravure process is a true “intaglio” (i.e., cut-in or sunken) printing process. Rotogravure processes print directly from unconnected cells engraved into a plate cylinder. Ink is then applied to the engraved areas and doctored, or wiped off, the smooth non-image areas. The resulting inked image is then impressed onto the substrate to be printed. Typical print cylinders in rotogravure processes are machined, electroplated with copper, ground, and polished. The cells holding the ink are not interconnected; therefore, a checkerboard or saw tooth pattern shows up around the print edges—a characteristic of gravure printing. To overcome these deficiencies, very fine screen sizes are used to make the rough edges as inconspicuous as possible. The cylinder's print areas are etched as microscopic cup-like cells while non-print areas remain untouched: the larger and bolder the copy, the larger and deeper the etched cells. Fine tonal areas typically have a smaller cell size and depth. Inks suitable for use in a rotogravure process may be fluid and have very low viscosity.

A second process for printing paper web structures involves flexographic methods. Flexographic printing methods are methods of direct rotary printing that use resilient relief-image plates of rubber or photopolymer materials. The plates are affixed to plate cylinders and are inked by a cell-structured ink metering “anilox” roll carrying a fast drying fluid ink to plates that print onto virtually any substrate, absorbent or non-absorbent. An image is produced for every revolution of the printing plate cylinder. The printing plate cylinder is typically suitable for re-use with multiple designs depending upon the repeat pattern and web material width. Flexographic processes were developed primarily for printing onto packaging substrates where materials are commonly supplied in roll form for feeding into form/fill, overwrapping, bag making, and other continuous web processing machinery. As would be known to those of skill in the art, flexographic printing processes may use either solvent or water-based low viscosity inks that dry very quickly between the print stations of a press.

In one embodiment the tissue package and the fibrous structure both comprise a design representing the same style group.

Consumers want their home or work decor to be visually pleasing and well coordinated from a design standpoint. Consumer's natural desire to coordinate items within a room into one or more common design themes requires them to learn more about home décor and design principles. However, consumers are very busy with work, children, and activities. A simple and highly visual presentation of information of these principles would be helpful. Moreover, the combination of home décor tips, illustrations, and patterns on a consumable product package that can be placed in room and viewed/analyzed over time provides an added level of confidence to the consumer that a change to a new style of décor will be appealing to herself and others who will be using the room on a regular basis.

Therefore, the present invention may comprise the additional step of providing décor information on the tissue product package selected from the group consisting of painting information, wallpaper information, candle scents, room accessory information, furniture information, flooring information, lighting information, decorating supplier information, decorating coupons, decorating supplier advertising, style group identifying information, and combinations thereof.

Furniture information may include brand names of brands of furniture and/or furniture collections that coordinate with the style group, retail stores that will supply these furniture brands and/or collections, websites (e.g. url) for online ordering or information, photographs or graphic renditions of furniture pieces or furniture collections that coordinate with the design or the style group, etc. Painting information may include sources of paint suppliers for color palettes that coordinate with the style group and/or the colors and graphics on the tissue product packaging, photographs of paint colors or color palettes that coordinate with the design or the style group, paint color numbers of paint colors that coordinate with the design or style group, etc. Wallpaper information may include sources of wallpaper suppliers, brand and styles numbers of wallpaper that will coordinate with the designs for each style group, websites (e.g. url) for online ordering or information, photographs or graphic renditions of wall paper that coordinate with the design or style group, etc. Room accessory information may include sources of accessory suppliers that will coordinate with the designs for each style group, websites (e.g. url) for online ordering or information, photographs or graphic renditions and ordering information for specific accessories that coordinate with the design to style group, etc. Flooring information includes sources of flooring suppliers that will coordinate with the designs for each style group, websites (e.g. url) for online ordering or information, photographs or graphic renditions of specific flooring or flooring collections that coordinate with the design or style groups, etc. Lighting information includes sources of lighting suppliers that will coordinate with the designs for each style group, websites (e.g. url) for online ordering or information, photographs or graphic renditions of specific lighting products or lighting collections that coordinate with the design or style group, etc. Decorating supplier information includes sources of fabric suppliers and/or artwork suppliers that coordinate with the design for each style group, photographs or graphic renditions of fabric and/or artwork or of fabric or artwork collections that coordinate with the design of each style group, websites (e.g. url) for online ordering or information, etc. The information may also comprise advertising or coupons for products that coordinate with the design of the style groups.

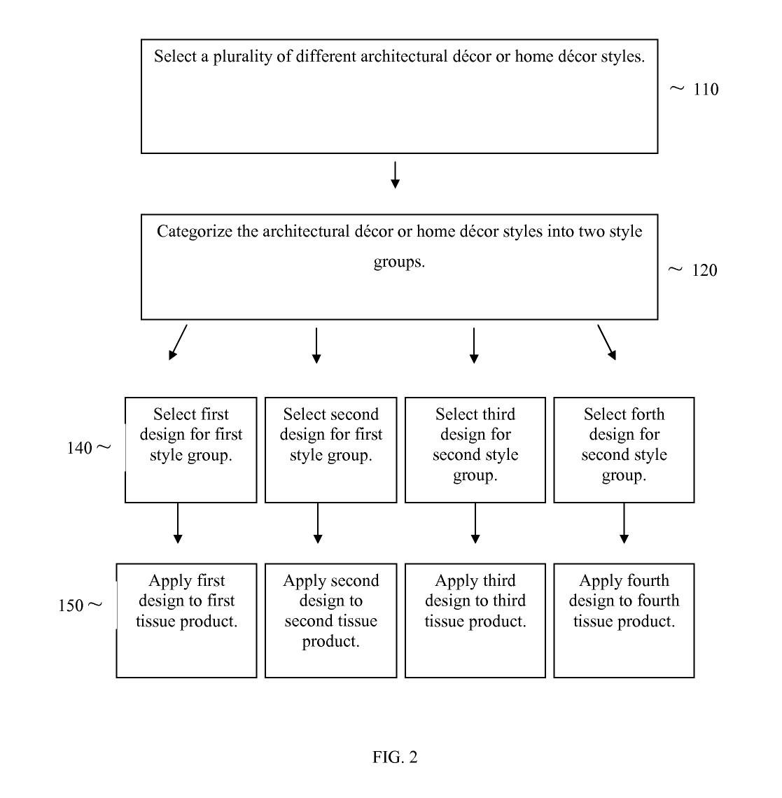

FIG. 2 illustrates another embodiment of the present invention. First a plurality of different architectural décor or home décor styles are selected 110, for example cottage, country, contemporary, French country, Scandinavian, transitional are selected. Then the architectural décor or home décor styles are categorized into two style groups 120, for example the first style group being general country (which includes cottage, country, French country), and the second style group being general contemporary (and includes contemporary, Scandinavian, and transitional). Thereafter designs are selected that represent each style group 140. As shown in FIG. 2, a first design is selected for the first style group, a second design is selected for the first style group, a third design is selected for the second style group, and a forth design is selected for the second style group. For example a floral pattern may be selected as the first design for the general country style group and a second floral design may be selected for the second design of the general country style group. For example, a geometric pattern may be selected as the third design for the general contemporary style group and another geometric design may be selected for the forth design of the general contemporary style group. Additional designs, for example from about 2 to about 12 designs and/or from about 2 to about 6 designs, may be selected for each style group. The first design is then applied to a first tissue product, the second design is applied to a second tissue product, the third design is applied to a third tissue product and the forth design is applied to the forth tissue product 150. In another embodiment, the tissue products representing the same style group may be the same or different tissue products.

### Tissue Product

In one embodiment the tissue product comprises a tissue package and a fibrous structure, and the design is applied to the tissue package, the fibrous structure, and combinations thereof.

In one embodiment, the fibrous structure has a basis weight of about 15 lbs/3000 ft² to about 50 lbs/3000 ft². In another embodiment the basis weight is about 20 lbs/3000 ft² to about 40 lbs/3000 ft²; in another embodiment the basis weight is about 25 lbs/3000 ft² and about 40 lbs/3000 ft², and in another embodiment the basis weight is about 27 lbs/3000 ft² and about 37 lbs/3000 ft².

The tissue products may incorporate a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from wood pulp such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the paper is produced by forming a predominantly aqueous slurry comprising about 95% to about 99.9% water. The aqueous slurry can be pumped to the headbox of the papermaking process.

In one embodiment the present invention may comprise a co-formed fibrous structure. A co-formed fibrous structure comprises a mixture of at least two different materials wherein at least one of the materials comprises a non-naturally occurring fiber, such as a polypropylene fiber, and at least one other material, different from the first material, comprising a solid additive, such as another fiber and/or a particulate. In one example, a co-formed fibrous structure comprises solid additives, such as naturally occurring fibers, such as wood pulp fibers, and non-naturally occurring fibers, such as polypropylene fibers.

Synthetic fibers useful herein include any material, such as, but not limited to polymers, such as those selected from the group consisting of polyesters, polypropylenes, polyethylenes, polyethers, polyamides, polyhydroxyalkanoates, polysaccharides, and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or a mixture to make up the entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) otherwise known as “CoPET/PET” fibers, which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

These multicomponent and/or synthetic fibers are further described in U.S. Pat. Nos. 6,746,766, issued on Jun. 8, 2004; 6,946,506, issued Sep. 20, 2005; 6,890,872, issued May 10, 2005; US Publication No. 2003/0077444A1, published on Apr. 24, 2003; US Publication No. 2003/0168912A1, published on Nov. 14, 2002; US Publication No. 2003/0092343A1, published on May 15, 2003; US Publication No. 2002/0168518A1, published on Nov. 14, 2002; US Publication No. 2005/0079785A1, published on Apr. 14, 2005; US Publication No. 2005/0026529A1, published on Feb. 3, 2005; US Publication No. 2004/0154768A1, published on Aug. 12, 2004; US Publication No. 2004/0154767, published on Aug. 12, 2004; US Publication No. 2004/0154769A1, published on Aug. 12, 2004; US Publication No. 2004/0157524A1, published on Aug. 12, 2004; US Publication No. 2005/0201965A1, published on Sep. 15, 2005.

The fibrous structure may comprise any tissue-towel paper product known in the industry. Embodiment of these structures may be made according U.S. Pat. Nos. 4,191,609 issued Mar. 4, 1980 to Trokhan; 4,300,981 issued to Carstens on Nov. 17, 1981; 4,191,609 issued to Trokhan on Mar. 4, 1980; 4,514,345 issued to Johnson et al. on Apr. 30, 1985; 4,528,239 issued to Trokhan on Jul. 9, 1985; 4,529,480 issued to Trokhan on Jul. 16, 1985; 4,637,859 issued to Trokhan on Jan. 20, 1987; 5,245,025 issued to Trokhan et al. on Sep. 14, 1993; 5,275,700 issued to Trokhan on Jan. 4, 1994; 5,328,565 issued to Rasch et al. on Jul. 12, 1994; 5,334,289 issued to Trokhan et al. on Aug. 2, 1994; 5,364,504 issued to Smurkowski et al. on Nov. 15, 1995; 5,527,428 issued to Trokhan et al. on Jun. 18, 1996; 5,556,509 issued to Trokhan et al. on Sep. 17, 1996; 5,628,876 issued to Ayers et al. on May 13, 1997; 5,629,052 issued to Trokhan et al. on May 13, 1997; 5,637,194 issued to Ampulski et al. on Jun. 10, 1997; 5,411,636 issued to Hermans et al. on May 2, 1995; EP 677612 published in the name of Wendt et al. on Oct. 18, 1995, and U.S. Patent Application 2004/0192136A1 published in the name of Gusky et al. on Sep. 30, 2004.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. Nos. 6,048,938 issued to Neal et al. on Apr. 11, 2000; 5,942,085 issued to Neal et al. on Aug. 24, 1999; 5,865,950 issued to Vinson et al. on Feb. 2, 1999; 4,440,597 issued to Wells et al. on Apr. 3, 1984; 4,191,756 issued to Sawdai on May 4, 1980; and 6,187,138 issued to Neal et al. on Feb. 13, 2001.

Conventionally pressed tissue paper and methods for making such paper are known in the art, for example U.S. Pat. No. 6,547,928 issued to Barnholtz et al. on Apr. 15, 2003. Processes for making pattern densified tissue webs are disclosed in U.S. Pat. No. 3,301,746, issued to Sanford, et al. on Jan. 31, 1967; U.S. Pat. No. 3,974,025, issued to Ayers on Aug. 10, 1976; U.S. Pat. No. 4,191,609, issued to on Mar. 4, 1980; and U.S. Pat. No. 4,637,859, issued to on Jan. 20, 1987; U.S. Pat. No. 3,301,746, issued to Sanford, et al. on Jan. 31, 1967; U.S. Pat. No. 3,821,068, issued to Salvucci, Jr. et al. on May 21, 1974; U.S. Pat. No. 3,974,025, issued to Ayers on Aug. 10, 1976; U.S. Pat. No. 3,573,164, issued to Friedberg, et al. on Mar. 30, 1971; U.S. Pat. No. 3,473,576, issued to Amneus on Oct. 21, 1969; U.S. Pat. No. 4,239,065, issued to Trokhan on Dec. 16, 1980; and U.S. Pat. No. 4,528,239, issued to Trokhan on Jul. 9, 1985.

Uncompacted, non pattern-densified tissue paper structures are also contemplated within the scope of the present invention and are described in U.S. Pat. No. 3,812,000 issued to Joseph L. Salvucci, Jr. et al. on May 21, 1974; and U.S. Pat. No. 4,208,459, issued to Henry E. Becker, et al. on Jun. 17, 1980. Uncreped tissue paper as defined in the art are also contemplated. The techniques to produce uncreped tissue in this manner are taught in the prior art. For example, Wendt, et al. in European Patent Application 0 677 612A2, published Oct. 18, 1995; Hyland, et al. in European Patent Application 0 617 164 A1, published Sep. 28, 1994; and Farrington, et al. in U.S. Pat. No. 5,656,132 issued Aug. 12, 1997.

Uncreped tissue paper, in one embodiment, refers to tissue paper which is non-compressively dried, by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, Wendt, et al. in European Patent Application 0 677 612A2, published Oct. 18, 1995; Hyland, et al. in European Patent Application 0 617 164 A1, published Sep. 28, 1994; and Farrington, et. al. in U.S. Pat. No. 5,656,132 published Aug. 12, 1997.

In one embodiment, the fibrous substrate is a through air dried paper made according to the foregoing patents and has a plurality of domes formed during the papermaking process which are dispersed throughout an essentially continuous network region. The domes extend generally perpendicular to the paper and increase its caliper. The domes generally correspond in geometry, and during papermaking in position, to the deflection conduits of the belt described above. There are an infinite variety of possible geometries, shapes, and arrangements for the deflection conduits and the domes formed in the paper therefrom. These shapes include those disclosed in commonly assigned U.S. Pat. No. 5,275,700 issued on Jan. 4, 1994 to Trokan. Examples of these shapes include, but are not limited to those described as a bow-tie pattern or snowflake pattern. Further examples of these shapes include, but are not limited to, circles, ovals, diamonds, triangles, hexagons, and various quadrilaterals.

The domes that form the essentially continuous network of domes protrude outwardly from the plane of the paper due to molding into the deflection conduits during the papermaking process. By molding into the deflection conduits during the papermaking process, the regions of the paper comprising the domes are deflected in the Z-direction.

If the fibrous structure has domes, or other prominent features in the topography, the domes, or other prominent feature, may be arranged in a variety of different configurations. These configurations include, but are not limited to: regular arrangements, random arrangements, multiple regular arrangements, and combinations thereof.

The fibrous structure product according to the present invention having domes may be made according to commonly assigned U.S. Pat. No. 4,528,239 issued Jul. 9, 1985 to Trokhan; U.S. Pat. No. 4,529,480 issued Jul. 16, 1985 to Trokhan; U.S. Pat. No. 5,275,700 issued Jan. 4, 1994 to Trokhan; U.S. Pat. No. 5,364,504 issued Nov. 15, 1985 to Smurkoski et al.; U.S. Pat. No. 5,527,428 issued Jun. 18, 1996 to Trokhan et al.; U.S. Pat. No. 5,609,725 issued Mar. 11, 1997 to Van Phan; U.S. Pat. No. 5,679,222 issued Oct. 21, 1997 to Rasch et al.; U.S. Pat. No. 5,709,775 issued Jan. 20, 1995 to Trokhan et al.; U.S. Pat. No. 5,795,440 issued Aug. 18, 1998 to Ampulski et al.; U.S. Pat. No. 5,900,122 issued May 4, 1999 to Huston; U.S. Pat. No. 5,906,710 issued May 25, 1999 to Trokhan; U.S. Pat. No. 5,935,381 issued Aug. 10, 1999 to Trokhan et al.; and U.S. Pat. No. 5,938,893 issued Aug. 17, 1999 to Trokhan et al.

In one embodiment the fibrous structure is made using the papermaking belt as disclosed in U.S. Pat. No. 5,334,289, issued on Aug. 2, 1994, Paul Trokhan and Glenn Boutilier.

Suitable means of laminating the plies include but are not limited to those methods disclosed in commonly assigned U.S. Pat. Nos. 6,113,723 issued to McNeil et al. on Sep. 5, 2000; 6,086,715 issued to McNeil on Jul. 11, 2000; 5,972,466 issued to Trokhan on Oct. 26, 1999; 5,858,554 issued to Neal et al. on Jan. 12, 1999; 5,693,406 issued to Wegele et al. on Dec. 2, 1997; 5,468,323 issued to McNeil on Nov. 21, 1995; 5,294,475 issued to McNeil on Mar. 15, 1994.

The fibrous structure product may be in roll form. When in roll form, the fibrous structure product may be wound about a core or may be wound without a core.

In one example, tissue products comprise a plurality of single- and/or multi-ply sanitary tissue products. The sanitary tissue products may be dry and/or wet. The sanitary tissue products may come in a variety of roll sizes and may be packaged in different numbers of rolls, such as four, six, nine, twenty-four, thirty-six and the like. The packages may be displayed on a shelf at a point of sale, such as within a retail store, in such as way that the different sanitary tissue products or packages are visible to a consumer during the consumer's purchasing decision process. The package may comprise a mixture of single-ply and multi-ply sanitary tissue products.

### EXAMPLE

In an embodiment of the present invention, first a plurality of different architectural décor or home décor styles are selected. The styles selected are cottage, country, contemporary, French country, Scandinavian, transitional, and traditional. Thereafter, consumers are presented via the internet, with a questionnaire to obtain data to categorize the home décor and architectural décor styles into style groups. Based on this data, the architectural décor or home décor styles are categorized into three style groups. The first style group is general country (which includes cottage, country, French country), the second style group is general contemporary (includes contemporary, Scandinavian, and transitional), and the third style group is traditional.

Consumers are presented, via the internet, with a questionnaire to obtain data to select the most appropriate designs that represent each of the three style groups. Based on this data, from about 3 to about 20 designs are selected to represent each of the three style groups. Specifically, about 8 to about 15 designs are selected for the first style group, from about 8 to about 15 designs are selected for the second style group, and from about 8 to about 15 designs are selected for the third style group.

A different fibrous structure is selected for each style group. These fibrous structures may vary based on the softness of the fibrous structure, the tensile strength, the number of plies, the degree of absorbency, the type of fibers used or the mixture of fibers used, the presence of lotions or other active ingredients on the fibrous structure, the price category of the tissue product, etc.

The first designs are applied to the first tissue products, the second designs are applied to the second tissue products, and the third designs are applied to the third tissue products. Painting information is applied to the tissue products as well. This painting information comprises a color palette that aids the consumer in selecting paint colors, fabric selections, wallpaper selections, accessory information, etc. that will coordinate with the style group, designs and colors on the tissue product.

All measurements referred to herein are made at 23+/−1° C. and 50% relative humidity, unless otherwise specified. All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of customizing a tissue product, comprising the steps of:
selecting a plurality of different architectural décor or home décor styles;
categorizing the architectural décor or home décor styles into style groups;
selecting a plurality of style groups;
selecting at least one design that is representative of each style group;
applying the selected designs to one or more tissue products, so that the tissue products represent the style group.

2. The method of claim 1 wherein the tissue product comprises a tissue package and a fibrous structure, and the design is applied to the tissue package, the fibrous structure, and combinations thereof.

3. The method of claim 2 wherein the tissue package and the fibrous structure both comprise a design representing the same style group.

4. The method of claim 1 further comprising the step of providing décor information on the tissue package.

5. The method of claim 4 wherein the décor information on the package comprises a paint chip color palette that represents one or more paint colors that coordinate with the color palette used on the tissue package.

6. The method of claim 5 wherein the paint chip color palette represents one or more paint colors that coordinate with the style group.

7. The method of claim 4 wherein the décor information is selected from the group consisting of painting information, wallpaper information, candle scents, room accessory information, furniture information, flooring information, lighting information, decorating supplier information, decorating coupons, decorating supplier advertising, and combinations thereof.

8. The method of claim 1 further comprising providing an array of tissue products comprising at least about 2 tissue product groups, each tissue product group representing a different style group.

9. The method of claim 8 further comprising providing an array of tissue products comprising at least about 3 tissue product groups, each tissue product group representing a different style group.

10. The method of claim 8 wherein each group comprises a mixture of different types of tissue products selected from the group consisting of facial tissue products, toilet tissue products, paper towel products, and wipe products.

11. The method of claim 1 further comprising the step of conducting consumer research to determine the architectural décor or home décor styles, to determine designs that are representative of each style group, and combinations thereof.

12. A method of customizing a tissue product, comprising the steps of:
selecting a plurality of different architectural décor or home décor styles;
categorizing the architectural décor or home décor styles into style groups;
selecting a plurality of style groups;
selecting at least one design that is representative of each style group;
applying the selected designs to one or more tissue products, so that the tissue products represent the style group, wherein the tissue product comprises a tissue package;
providing décor information on the tissue package selected from the group consisting of painting information, wallpaper information, candle scents, room accessory information, furniture information, flooring information, lighting information, decorating supplier information, decorating coupons, decorating supplier advertising, style group identifying information, and combinations thereof.

13. The method of claim 2 wherein the tissue package comprises an indicia that represents the style group and a single source manufacturer.
